(19) United States
(12) Patent Application Publication
(10) Pub. No.: US 2014/0344707 A1
(43) Pub. Date: Nov. 20, 2014

(54) Information Distribution Method and Device

(71) Applicant: BEIJING QIHOO TECHNOLOGY COMPANY LIMITED, Xicheng, Beijing (CN)

(72) Inventors: Liang Zhang, Beijing (CN); Xiangying Ma, Beijing (CN); Shuang Yu, Beijing (CN)

(21) Appl. No.: 14/368,849

(22) PCT Filed: Dec. 18, 2012
(86) PCT No.: PCT/CN2012/086866

§ 371 Date: Jun. 26, 2014

(30) Foreign Application Priority Data
Dec. 30, 2011 (CN) 201110456962.4

(51) Int. Cl. G06F 3/0484; G06F 17/22

(52) U.S. Cl. CPC G06F 3/0484; G06F 17/2247; G06F 3/04845
USPC 715/747

(57) ABSTRACT

Disclosed are an information distribution method and device. The method comprises: displaying an information distribution entrance in a browser interface; determining information to be distributed according to currently opened network resource contents when receiving an information distribution request of a user from the information distribution entrance; and distributing to a social network account of the user the information to be distributed. The present invention can effectively increase the information distribution efficiency.

### FIELD OF THE INVENTION

The invention relates to the field of browser technologies, and in particular, to an information distribution method and device.

### BACKGROUND OF THE INVENTION

With the swift development and prevalence of internet technologies, people's dependence on the internet are becoming higher and higher, and obtaining information and messages from the internet has already become people's main source of information. However, a user will not be content with obtaining information only, but wish to be able to distribute his own information, and even interact with other users on a network, for example, to publish a review about a certain news event, to express his own mood, or to share what he himself has seen and heard with others on the network, and the like. Correspondingly, a social network platform thus was born.

There are various forms of social network platform, for example, one of them is the microblog platform. The so-called microblog, i.e., an abbreviation for micro-blog, is a platform for information sharing, dissemination and acquisition based on user relationships in which a user may establish a personal community by way of WEB, WAP (Wireless Application Protocol) or a variety of other clients, update information with a text of about 140 words, and realize instant sharing.

In the prior art, when distributing information through a social network platform, a user needs to first log in his own account, then inputs into an input box information that he wants to input, or selects content that needs to be distributed from other interface and afterwards copies and pastes it into the input box, and then clicks a button such as submit, etc. to finish the process of information distribution. Clearly, this process requires the user to carry out a series of operations, and thereby the efficiency of information distribution is greatly limited.

### SUMMARY OF THE INVENTION

In view of the above problems, the invention is proposed to provide an information distribution device and a corresponding information distribution method which overcome the above problems or at least in part solve or mitigate the above problems.

According to an aspect of the invention, there is provided an information distribution method comprising:

displaying an information distribution entrance in a browser interface;

determining information to be distributed according to currently opened network resource content when receiving an information distribution request of a user from the information distribution entrance; and

distributing the information to be distributed to a social network account of the user.

According to another aspect of the invention, there is provided an information distribution device comprising:

a first entrance providing unit configured to display an information distribution entrance in a browser interface;

an information determining unit configured to determine information to be distributed according to currently opened network resource content when receiving an information distribution request of a user from the information distribution entrance; and

an information distributing unit configured to distribute the information to be distributed to a social network account of the user.

According to yet another aspect of the invention, there is provided a computer program comprising a computer readable code which causes a server to perform the information distribution method according to any of claims 1-7, when said computer readable code is running on the server.

According to still another aspect of the invention, there is provided a computer readable medium storing the computer program as claimed in claim 15 therein.

The beneficial effects of the invention lie in that:

By way of the invention, an information distribution entrance may be provided directly in an interface of a browser, and after a user clicks the information distribution entrance, the browser may automatically distribute information to be distributed to a social network account of the user after the information to be distributed is determined. As such, if in the process of browsing a web page using the browser, the user finds some information that he wants to distribute to his own social network account, he may distribute such content into his own social network account directly via the information distribution entrance, and the information distribution may be realized conveniently and swiftly without the need for the user to carry out a series of operations such as switching to a social network page and inputting or pasting content to an input box, and the like. Moreover, since it is a function provided directly by the browser, its versatility is stronger, namely, it is of a universal applicability to all the web pages, and can effectively increase the efficiency of information distribution.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows schematically a flowchart of a method according to an embodiment of the invention;

FIG. 2 shows schematically a schematic diagram of a device according to an embodiment of the invention;

FIG. 3 shows schematically a block diagram of a server for carrying out a method according to the invention; and

FIG. 4 shows schematically a storage unit for retaining or carrying a program code implementing a method according to the invention.

### DETAILED DESCRIPTION OF THE INVENTION

In the following the invention will be further described in connection with the drawings and the particular embodiments.

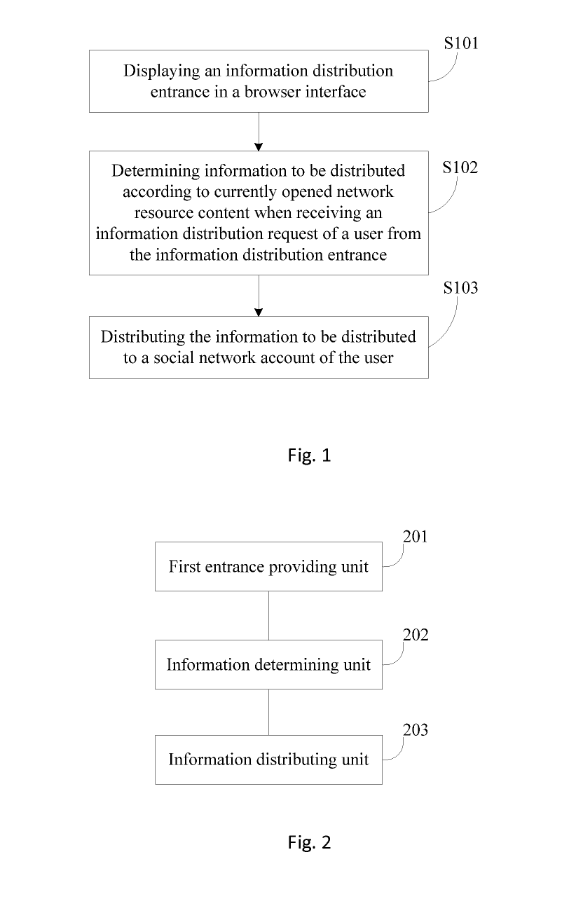

With reference to FIG. 1, an information distribution method provided by an embodiment of the invention comprises the following steps.

In S101, displaying an information distribution entrance in a browser interface.

In a particular implementation, the information distribution entrance may be displayed in an address bar, a sidebar, a toolbar, or a popup window, etc. of a browser. The information distribution entrance may take many forms, for example, it may be an operable button, etc. In a particular implementation, an icon may be shown on the right side of the address bar, and when a user moves the mouse over the icon, prompt information such as “send a microblog” etc. may be displayed. Meanwhile, the icon may receive a click operation of the user, and when the user clicks the icon, it proves that the user enters from the information distribution entrance and wants to conduct the operation of sending a microblog.

In S102, determining information to be distributed according to currently opened network resource content when receiving an information distribution request of the user from the information distribution entrance.

As described above, when the user performs an operation such as clicking the icon, etc., it proves that the user enters from the information distribution entrance and wants to conduct the operation of sending a microblog, and at this point, it may be first determined what the information to be distributed is. For example, in a simplest way, the URL (Uniform/Universal Resource Locator) of a web page currently in focus and the headline of the web page may be directly determined as the information to be distributed. Therein, each web page has its own URL, and it is displayed in the address bar of the browser, and therefore, the browser may directly go to the address bar to grab the URL of the web page currently in focus. As for the headline of the web page, normally, a web page maker will provide a web page headline for each web page, and at this point, the browser may equally directly obtain the headline. If there are no web page headlines for some web pages, it may also analyze the text content, etc. in a web page, extract therefrom words capable of representing the main content of the web page as the web page headline, and then the web page headline provided by the browser for the web page is taken as the information to be distributed.

Of course, for the convenience of determination by the user, it is possible to pop up a window, automatically fill the URL and the web page headline in the popup window respectively, and then determine such information to be the information to be distributed after the user clicks a button such as “confirm”, etc. in the window. As such, if in the process of browsing a certain web page, the user finds that the content in the web page is relatively interesting and wants to distribute the URL of the website out via a microblog, etc. to share it with other users, the user may directly click the information distribution entrance provided in the browser interface, and take the URL of the website and the web page headline as the content to be distributed without the need to manually carry out an operation such as select as well as copy and paste, etc.

The above example is relatively convenient for a case in which the user wants to share all the content in the web page, however, in a practical application, such a case may further exist in which the user only wants to distribute out part of the content in a certain web page or the main content of the text in a web page. In this connection, in an embodiment of the invention, after the user enters from the information distribution entrance, it may also be that the summary information is extracted automatically by the browser from the page currently in focus and such summary information is determined as the information to be distributed. Therein, when extracting the summary information of the page, the browser may first grab the content in the page, and then perform a semantic analysis on the grabbed content, thereby extracting the summary information. As for a particular implementation method with which the browser performs a semantic analysis on the grabbed content, prior art methods may be employed to implement it, and hence it will not be repeated here any more. Of course, for the summary content extracted by the browser, it may further allow the user to edit, for example, the user may add a text therein, or delete part of the description therein, and so on.

Furthermore, if the user needs to distribute part of the content in a currently browsed web page to a social network account, he himself may also manually select the content that needs to be distributed, and then the browser determines the part of content selected by the user to be the information to be distributed. In such a case, the user may first conduct the operation of selecting content, then click the information distribution entrance given by the browser, and thus, the browser may directly display the content selected by the user in a popup window, and may directly determine the part of content to be the information to be distributed after confirmation by the user.

It needs to be noted that, a social network platform such as the microblog, etc. might limit the number of words to be distributed, for example, each microblog is limited not to exceed 140 words, and the like. Therefore, whether the URL of a web page and the web page headline are taken as the content to be distributed, or the content summary of a web page is extracted, or the content selected by the user is taken as the information to be distributed, the limitation to the number of words may be taken into account at the same time. For example, when the total number of words of the URL of a web page and the web page headline exceeds the word limit, the web page headline may be first truncated and then distributed; or, the extracted summary is controlled not to exceed the word limit; or, when the text content selected by the user exceeds the word limit, a prompt is sent out to the user, and the like.

In S103, distributing the information to be distributed to the social network account of the user.

After the information to be distributed is determined, such information may be distributed to the social network account of the user. In a practical application, it may be that the user uses his own social network account to complete the login in advance, and with the social network account remaining in the login state, the information in the browser page may be directly distributed to the already logged-in social network account via the information distribution entrance in the browser. If the social network account is not logged in, then the browser may first enter the login page, and automatically send out the message to be distributed after the user completes the login. Or, the user's login information, e.g., the username, password and the URL of the social network, etc., may be recorded beforehand, and when the user enters by clicking from the information distribution entrance, it is possible to first log on to the user's account automatically utilizing the login information recorded beforehand, and then distribute the determined information to be distributed to the account. Of course, in this case, it needs to be done with the user's consent, for example, a prompt window may be popped up to the user, and the user's login information is recorded after the user agrees to use this function and offers his login information on his initiative.

It needs to be noted that, in general, if a user logs in his own social network account, then the login state may be kept, even if the page of the social network is closed, or the browser is closed, the machine is shut down, and so on, provided that the user does not manually perform the operation of “logout”. Therefore, in an embodiment of the invention, it is only required for the user to input the username and password of the social network in the browser with the information distribution entrance and log in the social network once, so as to be able to use the method of the invention to distribute information. When it is found there is content in which he himself is relatively interested in a certain web page, such content may be distributed via the information distribution entrance in the browser into this social network account he himself has already logged in before. For example, if a web page A is browsed and found to be very interesting, the information distribution icon may be clicked to distribute the URL of the web page A and the web page headline to his own microblog, and so on.

In a practical application, when distributing information, the user may further have the demand of sending an image, for example, sending his own present head portrait, etc. In an embodiment of the invention, to meet such a demand of the user, it is further possible that an operable identification such as “selecting an image”, etc. is popped up after the user clicks the information distribution entrance, the user may open the camera of an apparatus by clicking the identification, then take pictures and send the captured pictures together as the information to be sent to the social network account that the user has logged in.

By way of the invention, an information distribution entrance may be provided directly in an interface of a browser, and after a user clicks the information distribution entrance, the browser may automatically distribute information to be distributed to a social network account that the user has already logged in after the information to be distributed is determined. As such, if in the process of browsing a web page using the browser, the user finds some information that he wants to distribute to his own social network account, he may distribute such content into his own social network account directly via the information distribution entrance, and the information distribution may be realized conveniently and swiftly without the need for the user to carry out a series of operations such as switching to a social network page and inputting or pasting content to an input box, and the like. Moreover, since it is a function provided directly by the browser, its versatility is stronger, namely, it is of a universal applicability to all the web pages.

Correspondingly to the information distribution method provided by an embodiment of the invention, an embodiment of the invention further provides an information distribution device. See FIG. 2, the device comprises:

a first entrance providing unit 201 configured to display an information distribution entrance in a browser interface;

an information determining unit 202 configured to determine information to be distributed according to currently opened network resource content when receiving an information distribution request of a user from the information distribution entrance; and

an information distributing unit 203 configured to distribute the information to be distributed to a social network account of the user.

Therein, the information determining unit 202 may comprise:

a first determining subunit configured to determine the Uniform/Universal Resource Locator URL of a web page currently in focus and the headline of the web page to be the information to be distributed.

Or, the information determining unit 202 may also comprise:

a second determining subunit configured to grab the summary information from a page currently in focus and determine the grabbed summary information to be the information to be distributed.

Moreover, the information determining unit 202 may further comprise:

a third determining subunit configured to determine the content selected by the user from a page to be the information to be distributed.

In a practical application, the device may further comprise:

a second entrance providing unit configured to provide the user with an entrance for selecting an image; and

a camera device starting unit configured to start a camera device when the user enters from the entrance for selecting an image.

At this point, the information determining unit 202 may further comprise:

a fourth determining subunit configured to determine a picture/pictures taken by the camera device to be the information to be distributed.

In a particular implementation, the information distributing unit 203 may particularly comprise:

a first distributing subunit configured to distribute the information to be distributed to the social network account that the user has currently logged in; or

a second distributing subunit configured to log in the user's social network account according to the user's login information recorded beforehand and distribute the information to be distributed to the social network account.

Therein, the first entrance providing unit 201 may be particularly configured to display the information distribution entrance in an address bar, a toolbar, a sidebar, or a popup window of a browser.

By way of the invention, an information distribution entrance may be provided directly in an interface of a browser, and after a user clicks the information distribution entrance, the browser may automatically distribute information to be distributed to a social network account that the user has already logged in after the information to be distributed is determined. As such, if in the process of browsing a web page using the browser, the user finds some information that he wants to distribute to his own social network account, he may distribute such content into his own social network account directly via the information distribution entrance, and the information distribution may be realized conveniently and swiftly without the need for the user to carry out a series of operations such as switching to a social network page and inputting or pasting content to an input box, and the like. Moreover, since it is a function provided directly by the browser, its versatility is stronger, namely, it is of a universal applicability to all the web pages.

Embodiments of the individual components of the invention may be implemented in hardware, or in a software module running on one or more processors, or in a combination thereof. It will be appreciated by those skilled in the art that, in practice, some or all of the functions of some or all of the components in an information distribution device according to embodiments of the invention may be realized using a microprocessor or a digital signal processor (DSP). The invention may also be implemented as an apparatus or a device program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

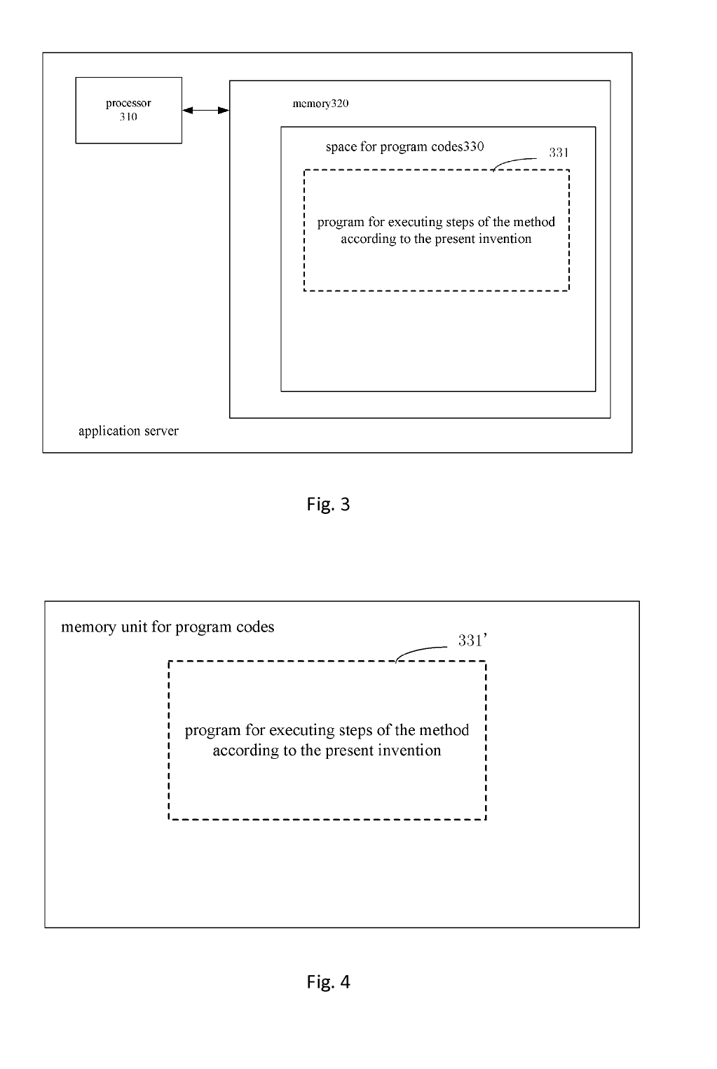

For example, FIG. 3 shows a server which may carry out an information distribution method according to the invention, e.g., an application server. The server traditionally comprises a processor 310 and a computer program product or a computer readable medium in the form of a memory 320. The memory 320 may be an electronic memory such as a flash memory, an EEPROM (electrically erasable programmable read-only memory), an EPROM, a hard disk or a ROM. The memory 320 has a memory space 330 for a program code 331 for carrying out any method steps in the methods as described above. For example, the memory space 330 for a program code may comprise individual program codes 331 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 4. The storage unit may have a memory segment, a memory space, etc. arranged similarly to the memory 320 in the server of FIG. 3. The program code may for example be compressed in an appropriate form. In general, the storage unit comprises a computer readable code 331′, i.e., a code which may be read by e.g., a processor such as 310, and when run by a server, the codes cause the server to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several devices, several of the devices may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. An information distribution method comprising:
displaying an information distribution entrance in a browser interface;
determining information to be distributed according to currently opened network resource content when receiving an information distribution request of a user from the information distribution entrance; and
distributing the information to be distributed to a social network account of the user.

2. The method as claimed in claim 1, wherein the step of determining information to be distributed comprises:
determining the Uniform/Universal Resource Locator URL of a web page currently in focus and the headline of the web page to be the information to be distributed.

3. The method as claimed in claim 1, wherein the step of determining information to be distributed comprises:
grabbing the summary information from a page currently in focus and determining the grabbed summary information to be the information to be distributed.

4. The method as claimed in claim 1, wherein the step of determining information to be distributed comprises:
determining the content selected by the user from a page to be the information to be distributed.

5. The method as claimed in claim 2, further comprising:
providing the user with an entrance for selecting an image; and
starting a camera device when the user enters from the entrance for selecting an image;
and, the step of determining information to be distributed further comprising:
determining a picture/pictures taken by the camera device to be the information to be distributed.

6. The method as claimed in claim 1, wherein the step of distributing the information to be distributed to a social network account of the user comprises:
distributing the information to be distributed to the social network account that the user has currently logged in; or
logging in the user's social network account according to the user's login information recorded beforehand and distributing the information to be distributed to the social network account.

7. The method as claimed in claim 1, wherein the step of displaying an information distribution entrance in a browser interface comprises:
displaying the information distribution entrance in an address bar, a toolbar, a sidebar, or a popup window of a browser.

8. An information distribution device comprising:
a first entrance providing unit configured to display an information distribution entrance in a browser interface;
an information determining unit configured to determine information to be distributed according to currently opened network resource content when receiving an information distribution request of a user from the information distribution entrance; and
an information distributing unit configured to distribute the information to be distributed to a social network account of the user.

9. The device as claimed in claim 8, wherein the information determining unit comprises:
a first determining subunit configured to determine the Uniform/Universal Resource Locator URL of a web page currently in focus and the headline of the web page to be the information to be distributed.

10. The device as claimed in claim 8, wherein the information determining unit comprises:
a second determining subunit configured to grab the summary information from a page currently in focus and determine the grabbed summary information to be the information to be distributed.

11. The device as claimed in claim 8, wherein the information determining unit comprises:
a third determining subunit configured to determine the content selected by the user from a page to be the information to be distributed.

12. The device as claimed in claim 9, further comprising:
a second entrance providing unit configured to provide the user with an entrance for selecting an image; and
a camera device starting unit configured to start a camera device when the user enters from the entrance for selecting an image;
and, the information determining unit further comprising:
a fourth determining subunit configured to determine a picture/pictures taken by the camera device to be the information to be distributed.

13. The device as claimed in claim 8, wherein the information distributing unit comprises:
a first distributing subunit configured to distribute the information to be distributed to the social network account that the user has currently logged in; or
a second distributing subunit configured to log in the user's social network account according to the user's login information recorded beforehand and distribute the information to be distributed to the social network account.

14. The device as claimed in claim 8, wherein the first entrance providing unit is particularly configured to display the information distribution entrance in an address bar, a toolbar, a sidebar, or a popup window of a browser.

15. (canceled)

16. A computer readable medium storing the computer program comprising computer readable codes, and running of said computer readable codes on a user terminal causes said user terminal to carry out a information distribution method, said method comprising:
displaying an information distribution entrance in a browser interface;
determining information to be distributed according to currently opened network resource content when receiving an information distribution request of a user from the information distribution entrance; and
distributing the information to be distributed to a social network account of the user.
